(19) United States
(12) Patent Application Publication
(10) Pub. No.: US 2003/0064161 A1
(43) Pub. Date: Apr. 3, 2003

(54) Method for reducing carbon contamination of multilayer mirrors

(76) Inventor: Michael E. Malinowski, Livermore, CA (US)

Correspondence Address: DONALD A. NISSEN, Sandia National Laboratories, MS 9031, 7011 East Avenue, Livermore, CA, 94550, US

(21) Appl. No.: 10/198,307

(22) Filed: Jul. 17, 2002

Related U.S. Application Data
(63) Continuation-in-part of application No. 09/876,386, filed on Jun. 6, 2001, now abandoned.

(51) Int. Cl. B05D 1/36

(52) U.S. Cl. 427/402

(57) ABSTRACT

A method for reducing carbon contamination of surfaces and particularly the surfaces of multilayer mirrors used for extreme ultraviolet (EUV) lithography by manipulating the surface electric phase field to reduce photoemission. Manipulation of the surface electric phase field can be by depositing a film, such as Si, or other low absorber of EUV radiation, to form a capping layer whose thickness is such that the near-surface electric field is a minimum. For extreme ultraviolet applications, where a multilayer Mo/Si mirror is used as a reflective optic, a capping layer of Si in the range of about 2-4 nm, and preferably 3 nm, is used.

### CROSS-REFERENCE TO RELATED APPLICATIONS

This application is a Continuation-in-Part of prior co-pending application Ser. No. 09/876,386, filed Jun. 6, 2001.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### FIELD OF THE INVENTION

The present invention is directed to a method for reducing carbon contamination of optical surfaces exposed to a combination of hydrocarbon vapor and high energy radiation by tailoring the intensity of the electric field near the optic surface. The invention is particularly directed to a method for reducing carbon contamination of the multilayer mirrors used in extreme ultraviolet lithography. A “capping” layer of the appropriate thickness can be used to minimize the near-surface electric field and, thereby reduce photoemission cracking of ambient hydrocarbon molecules and subsequent deposition of carbon.

### BACKGROUND OF THE INVENTION

The capabilities of conventional photolithographic techniques have been severely challenged by the need for circuitry of increasing density and higher resolution features. This is particularly true for advanced or next generation lithography where the goal is to produce circuits whose critical dimensions are below 0.1 μm. The demand for smaller feature sizes has inexorably driven the wavelength of radiation needed to produce the desired pattern to ever-shorter wavelengths. As the wavelength of the applied radiation is made shorter the energy of the radiation becomes greater, to the point where the radiation can cause the decomposition of molecules adsorbed on or proximate to a surface to produce reactive species that can attack, degrade, or otherwise contaminate the surface.

While short wavelength (high-energy) radiation can directly dissociate molecules, secondary electrons, created by the interaction of this radiation with surfaces, are the primary agents for molecular dissociation. Low energy (5-100 eV) secondary electrons are known to be very active in breaking chemical bonds by direct ionization of adsorbed molecules or by electron attachment, wherein a secondary electron binds to a molecule producing a reactive negative ion that then de-excites to a dissociated product. Any type of radiation (photons, electrons, ions, and particles) that is energetic enough to liberate electrons can create secondary electrons; typically, energies of about 4-5 eV are required. Consequently, radiation-induced contamination, i.e., contamination of surfaces by reactive species produced by secondary electrons originating from radiative interactions, will most certainly occur in lithographic processes that use energetic radiation such as: extreme ultraviolet lithography (photon energy≈100 eV), projection electron lithography (electron energy=50-100 keV), ion beam lithography (ion energy>10 keV), 193 nm lithography (photon energy≈6.4 eV) and 157 nm lithography (photon energy≈7.9 eV). Thus, the potential for contamination of critical lithographic components, such as masks and optical surfaces, and degradation of their operational capability is present in all the advanced lithographic processes.

Carbon deposition on optical surfaces resulting from the radiative decomposition of residual hydrocarbons in synchrotron beam line optical systems is well known in the art (A. Owens et al., Nucl. Instrum. Methods 208, 273, 1983). The build-up of these carbon deposits results in the loss of optical quality (reflectivity) and is undesirable. This is particularly so for extreme ultraviolet (EUV) lithography where small changes in reflectivity of optical components can have a disastrous effect on stepper performance. By way of example, exposure of a Si-terminated Mo/Si multilayer mirror to a flux density of about 4.2 mW/mm² of 13.4 nm radiation at a background pressure of hydrocarbon molecules of 1×10⁻⁹ Torr for about 6 hours results in the growth of a layer of graphitic carbon having a thickness of about 600 Å. This carbon film, produced by the secondary-electron-induced dissociation of hydrocarbon molecules adsorbed on the surface, reduced mirror reflectivity from 67% to 40%, a loss in reflectivity that would render the multilayer mirror inoperable in a lithographic stepper using multiple optical surfaces.

Various methods are available to clean contamination, and particularly carbon contamination, from surfaces, such as those disclosed in U.S. Pat. Nos. 5,312,519 “Method of Cleaning a Charged Beam Apparatus”′ issued to Sakai et al., 5,814,156, “Photoreactive Surface Cleaning”, issued to Elliott et al., and 5,362,330, “Process for the Emission-free, In Particular CFC-free, Cleaning of Precision Optics or Optical Element Groups”, issued to Preussner et al. However, these methods can either be unsuitable for cleaning reactive multilayer mirror surfaces or are capable of damaging the surface finish.

### SUMMARY OF THE INVENTION

Accordingly, the present invention provides a method for reducing carbon contamination of surfaces and particularly the surfaces of multilayer mirrors used for extreme ultraviolet (EUV), i.e., radiation having a wavelength of about 13.4 nm, lithography by minimizing the near-surface electric field at the multilayer mirror/vacuum interface. Changes in the phase of the electric field at a surface can be effected by applying a capping layer whose thickness can be a fraction of the wavelength of the radiation incident on the surface. It is preferable that the composition of the capping layer be such that the capped MLM have normal incidence reflectivity for EUV radiation that is at least 65%. The thickness of the capping layer is chosen such that the value of the near-surface electric field is a minimum. In this way, photoemission from the surface is minimized with a corresponding decrease in secondary electron cracking of ambient hydrocarbon vapors and subsequent surface carbon deposition.

### BRIEF DESCRIPTION OF THE DRAWINGS

FIGS. 1a and 1b illustrate the relationship between photoemission current and reflectivity.

FIG. 2 shows the effect of EUV+HC exposure on the reflectivity of a 4 nm Si-capped MLM.

FIG. 3 is a plot of initial photocurrent vs. calculated field interaction at a MLM/vacuum surface.

FIG. 4 shows the decrease in EUV reflectance of a Si/Mo MLM as a function of photon dose.

### DETAILED DESCRIPTION OF THE INVENTION

The present invention is directed to a method for reducing carbon deposition on surfaces, and particularly surfaces of multilayer mirrors (MLM) by minimizing the near-surface electric field at the multilayer mirror/atmosphere interface. This can be accomplished by providing a capping layer whose thickness can be adjusted to minimize the near-surface electric field and thereby reduce photoemission and consequent secondary electron induced decomposition of adsorbed hydrocarbon molecules.

The present invention will be illustrated and exemplified by a MLM system, consisting of a Mo/Si multilayer mirror system such as would be used for extreme ultraviolet lithography (EUVL). However, the method disclosed herein for reducing carbon buildup can be applicable to other MLMs. The example below is provided for purposes of clarity and understanding of the principles of this invention, the scope and extent of the invention is defined only by the concluding claims. In order to understand the present invention better, the following introductory discussion is provided.

Optics for short wavelength applications must be coated with multilayer reflectors. By way of example, as disclosed U.S. Pat. No. 6,110,607 issued to Montcalm et al. Aug. 29, 2000, a typical Mo/Si MLM used in EUVL is made by sputter depositing 40 pairs of alternating Mo and Si thin films, with a total (Si+Mo) bilayer thickness of ˜7 nm and a ratio of (Mo)/(Mo+Si) thicknesses of ˜0.4. It is preferred that the topmost layer be Si in order to minimize surface oxidation during routine handling. The thickness of this topmost or “capping” layer is ≈4.3 nm.

When EUV light is incident on a MLM a sinusoidally varying standing wave electric field is produced inside the mirror and just outside the mirror surface. The intensity of the electric field is proportional to the absolute magnitude of this electric field (the electric field squared |E²|), resulting in a standing wave with a period half the wavelength of the incident EUV radiation. The total energy deposited in the near-surface region of the MLM is proportional to the electric field intensity. It is known in the art that photoemission is directly related to the total energy deposition in the near-surface region of a MLM (cf. W. Gudat and C. Kunz, Phys. Rev. Lett., 29, 169, 1972 and A. Owens et al., Nucl. Instrum. Methods in Phys. Res., A385, 556, 1997). Thus, energy deposition in the near-surface region of a MLM is one of the factors that determine the strength of photoemission.

As discussed above, photoemission of secondary electrons is believed to be the parameter primarily responsible for cracking of adsorbed hydrocarbons and buildup of carbon deposits on the mirror surface. Consequently, by changing the near-surface structure of a MLM it is possible to minimize the electric field near the MLM surface and in principle the photoemission yield. There can be several ways to change the phase of the electric field. One particularly simple way is to choose a surface film having a thickness that minimizes the phase of the electric field and hence its intensity near the surface. In this way photoemission of electrons and attendant carbon buildup on mirror surfaces can be significantly reduced.

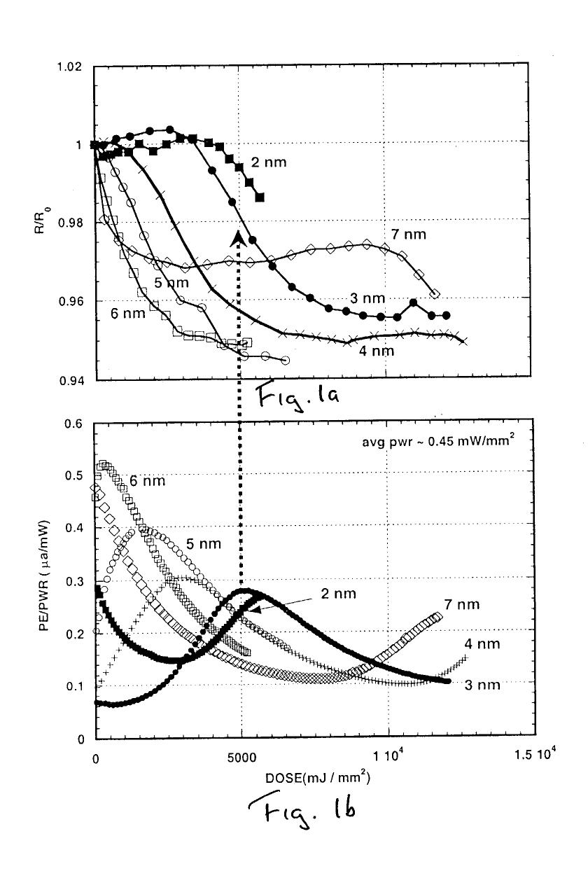

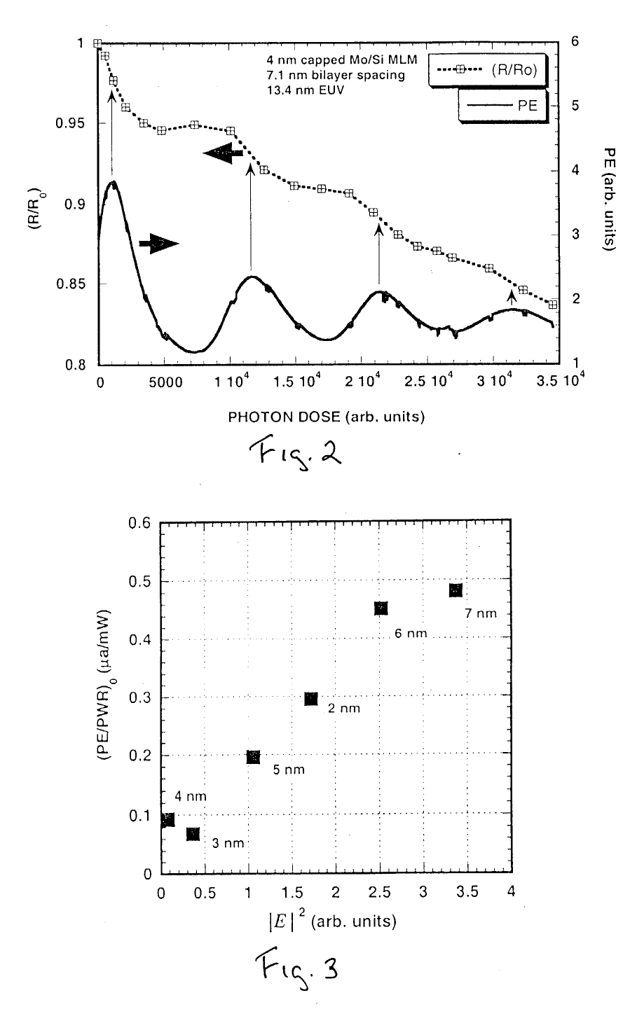

In order to determine the effect of capping layer thickness upon photoemission and consequent carbon deposition a series of Mo/Si MLMs were prepared having Si capping layer thickness ranging from 2 to 7 nm. These mirrors were all exposed to the same combination of EUV radiation (13.4 nm) and hydrocarbon (HC) vapors. The results of these exposures are shown in FIGS. 1a and 1b.

When studied together, FIGS. 1a and 1b show that there is a remarkable influence of the thickness of the silicon capping layer on both the relative reflectivity and photocurrent responses of the MLMs in a EUV+HC environment. The MLMs with capping layers of 2 nm and 3 nm maintain their original reflectivities the longest. Reflectivity measurements of MLMs having a Si capping layer ranging in thickness from 2-7 nm showed that the 3 nm MLM had an initial reflectivity which was the highest of all samples, including the one with 4 nm of Si capping layer. These results show that the 3 nm capping layer is the best choice for not only high initial reflectivity but also high resistance to degradation by carbon buildup. Although the 2 nm-capped MLM did maintain its reflectivity to a somewhat higher dose, it had been determined that it had a reflectivity about 1.5% lower than either the 3 nm or 4 nm capped MLM samples and therefore would not have higher absolute reflectivity than the 3 nm and 4 nm capped MLMs.

It should be noted that there is an approximate relationship between the shape of the reflectivity curve for each sample shown in FIG. 1a and matching photoemission curve for the same sample shown in FIG. 1b. For instance, the MLMs with 6 and 7 nm capping layers had high initial photoemission and their relative reflectivities decreased immediately. The photocurrent from the 3 nm sample, on the other hand, started low and reached a peak only after a dose of about 5000 mJ/mm². We note that there is a correlation between the peak in photocurrent characteristics and the region of most rapid decrease in relative reflectance. In FIGs 1a and 1b this point is emphasized by the arrow drawn between the photocurrent and relative reflectance data for the 3 nm-capped sample. As these figures show, the peak in photocurrent occurs around the dose where the reflectivity starts dropping most rapidly. This behavior is consistent with the notion that increased rate of carbon cracking is correlated with increased photoemission. Thus, where the photoemission is the highest, the carbon buildup rate should be the highest and the corresponding reflectivity decrease the greatest. In a separate study, the effect of EUV+HC exposure on a 4 nm capped Mo/Si was determined for times longer than those shown in FIGS. 1a and 1b. The results of this experiment are shown in FIG. 2, which shows the correspondence between photocurrent maxima (bottom curve) and regions of most rapid relative reflectivity drops (top curve). These oscillations in the photocurrent with increasing dose are consistent with the notion of a growing carbon layer whose vacuum interface is changing position relative to the standing wave electric field with increasing EUV+HC exposure. The local maxima and minima in photoemission approximately correspond to the carbon surface intersecting the standing wave field intensity at nodes and antinodes. Further, the physical thickness differences in carbon thickness between consecutive maxima (or minima) would be approximately half the EUV wavelength, or ˜6.7 nm.

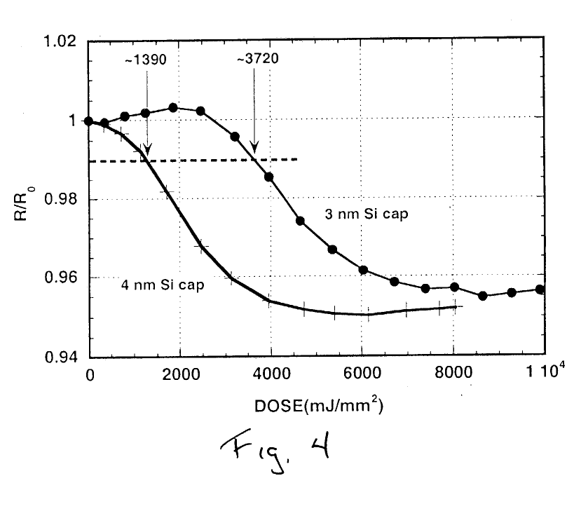

The data in FIGS. 1a and 1b also support the connection between the photocurrent (or photoemssion) for all the initially uncontaminated (zero dose) MLM samples and the surface electric field intensity. FIG. 3 shows the result of plotting the initial (zero dose, uncontaminated in FIG 1b), experimental photocurrents of all samples versus the calculated electric field intensities expected at the MLM/vacuum surface. These data show that there is indeed a good correlation between this surface field intensity and the initial photoemission experimentally observed, a correlation that supports the notion of the standing wave at the near-surface MLM/vacuum interface.

As discussed above, upon exposure to incident radiation, a standing wave electric field is formed just inside and just outside a mirror surface whose phase can be changed by subtle changes in the near-surface structure of the multilayer mirror. In particular, a change in the thickness of the Si capping layer deposited on the surface of the Mo/Si multilayer mirror will change the electric field phase or intensity. By this means it is possible to affect the photoemission current and, as a consequence, mirror reflectivity caused by carbon deposition. This is shown graphically in FIG. 4 which shows the decrease in original reflectance of a MLM as a function of the photon dose for two samples, a 4 nm Si capping layer, such as disclosed by Montcalm et al., and a 3 nm Si capping layer that, as shown above, is preferred to minimize carbon deposition. The 3 nm capping layer requires about 3 times the EUV radiation dose than does the 4 nm capping layer (3720 mJ/mm² vs. 1390 mJ/mm²) to cause a 1% drop in reflectivity.

As demonstrated above, changes to the surface structure of a multilayer mirror to minimize the surface electric field can minimize photoelectron emission and reduce reflectivity changes due to carbon buildup. For the Mo/Si multilayer mirrors used in EUVL, depositing a 3 nm thick Si surface layer has been shown to more effectively control the intensity of the surface field of the multilayer mirror and thus the rate of carbon deposition on the MLM surface than a prior art 4 nm capping layer.

I claim:

1. A method for reducing carbon build-up on multilayer mirror surfaces, comprising:
depositing a capping layer on the surface of the multilayer mirror, wherein the thickness of the capping layer is chosen so that the value of the surface electric field intensity is a minimum.

2. The method of claim 1, wherein the capping layer is Si.

3. A method for reducing carbon build-up on the surface of a Mo/Si multilayer mirror, comprising:
depositing a layer of Si on the surface of the Mo/Si mirror, wherein the thickness of the layer of Si is in the range of about 2-4 nm thick.

4. The method of claim 3, wherein the layer of Si is 3 nm thick.

5. A capping layer for multilayer mirrors, wherein the thickness of the capping layer is chosen so that the value of the surface electric field intensity is a minimum.
